(19) United States
(12) Patent Application Publication
(10) Pub. No.: US 2008/0314103 A1
(43) Pub. Date: Dec. 25, 2008

(54) DEVICE FOR PROTECTING A LOCK FROM THE ELEMENTS

(76) Inventor: Melvin Corlija, Columbia, MO (US)

Correspondence Address: KIMSEY PATENT SERVICES, LLC, 804 SHAMROCK AVENUE, BOONVILLE, MO, 65233, US

(21) Appl. No.: 11/765,130

(22) Filed: Jun. 19, 2007

(51) Int. Cl. E05B 17/18

(52) U.S. Cl. 70/455

(57) ABSTRACT

A device for protecting a lock, the device including a protective covering for protecting a lock, an annular sealing portion extending along at least a portion of a perimeter of the protective covering and fixedly attached thereto, and an attachment portion fixedly attached to the protective covering, the attachment portion being adapted to be removably attached to the lock being protected.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

Modern locks typically include numerous moving parts that are vital to the proper functioning of the lock. These parts include, for example, pins found in common house locks, car door locks, and the like, as well as a cam that is often turned using the proper key for a given lock. If any of these or other moving parts of a lock do not function properly, the lock may become non-functional, and a person will be unable to manipulate the car door, house door, or other structure protected by the lock into an unlocked position.

Locks often become inoperable due to weather in areas where the ambient temperature drops from time to time below the freezing point of water. In such areas, water from rain, snowmelt, or other sources may enter into the lock and freeze, thereby causing the movable internal components of the lock to become frozen as well. Further, the surface of the lock may become frozen such that ice prevents insertion of a key into the lock. In such cases, a person attempting to manipulate the lock will be unable to do so without first dealing with the ice that has formed on the inside or outside of the lock or, in some cases, on both the inside and outside of the lock. Using physical force such as by a vigorous turning of a key that has been inserted into a lock can damage the internal components of the lock, thereby rendering it entirely inoperable.

Many common solutions exist in order to deal with the problem of frozen locks. For example, people may inject anti-freezing chemicals into a lock prior to the advent of freezing temperatures, or may spray thawing chemicals onto the lock or into the interior of the lock after freezing has occurred. Physical means of heating the lock in order to thaw it, such as with a typical lighter or other heat source, are also commonly used. Each of these techniques suffers from drawbacks. Chemical solutions, for example, require a person to have such chemicals on-hand, and also result in the introduction of chemicals into the lock and the environment, neither of which may be ultimately desirable. Further, using chemicals may result in a risk of damage to the door or other structure in which the lock is installed. Physical means, such as by applying flame or other heat to the lock in order to thaw it also risk damage to the door or other structure in which the lock is installed. Furthermore, use of a flame or other heat source, as well as chemical means of thawing a lock, can potentially introduce a risk of harm to the person attempting to thaw the lock.

What is needed, therefore, is a device for safely preventing the freezing of locks during inclement weather conditions.

### SUMMARY OF THE INVENTION

The present invention provides a device for protecting a lock, the device including a protective covering for protecting a lock, an annular sealing portion extending along at least a portion of a perimeter of the protective covering and fixedly attached thereto, and an attachment portion fixedly attached to the protective covering, the attachment portion being adapted to be removably attached to the lock being protected.

In one aspect of the present invention, the protective covering is substantially circular in shape.

In another aspect of the present invention, the attachment portion includes an opening containing a magnet for attaching the device to a lock.

In another aspect of the present invention, the sealing portion includes at least one magnet to aid in the sealing of the present device to a surface in which a lock being protected is located.

In another aspect of the present invention, the attachment portion includes an adhesive for removably attaching the device to a lock.

In another aspect of the present invention, the attachment portion includes a protruding portion, which is in some cases a mock key, for attaching the present device to a lock.

In another aspect of the present invention the protective covering includes a graphical portion.

### BRIEF DESCRIPTION OF THE DRAWINGS

FIG. 1 is a cross-sectional view of a lock protection device constructed in accordance with the teachings of the present invention.

### DETAILED DESCRIPTION OF THE INVENTION

The present invention provides a device for preventing locks, such as locks used on car doors, house doors, and the like, for example, from becoming frozen during inclement weather due to accumulation and freezing of water within the lock or on the surface of the lock. The present device attaches to a lock and provides a physical barrier to protect the lock from such freezing.

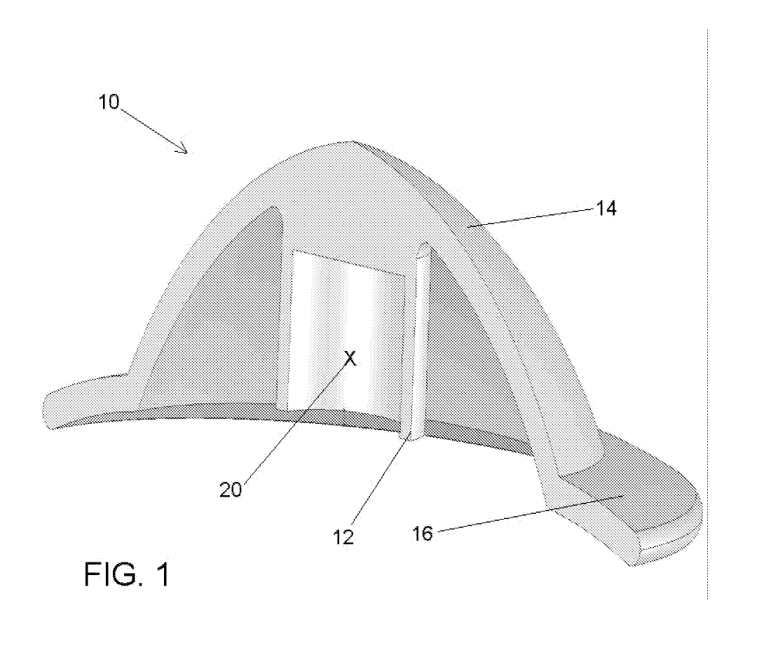

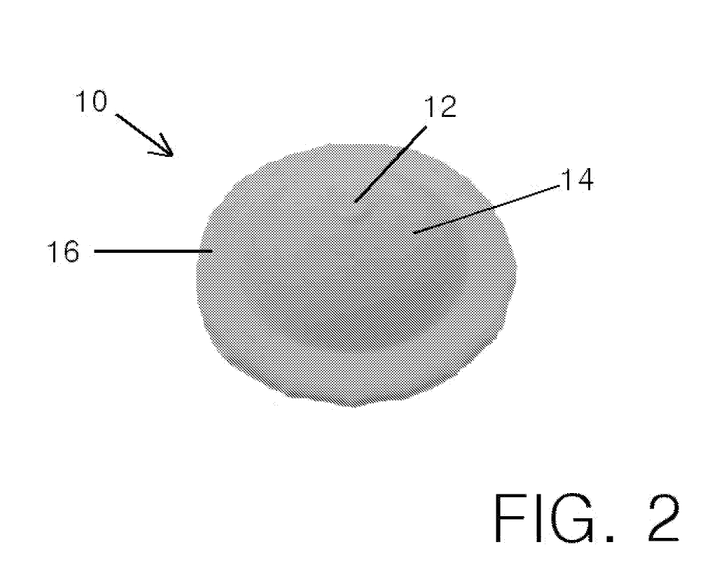

Turning now to the drawings, wherein like numerals indicate like parts, numeral 10 refers generally to a lock protection device constructed in accordance with the principles of the present invention. As can be seen from FIG. 1, lock protection device 10 preferably includes a central attachment portion 12, a protective covering 14, and an annular sealing portion 16. The use of lock protection device 10, along with the functionality of the various components thereof, is now described.

Use of lock protection device 10 is relatively straightforward. Attachment portion 12 of device 10 is preferably removably attachable to an exterior surface of a lock, thereby holding lock protection device 10 in place. In the embodiment of the present invention shown in the figures, attachment portion 12 of device 10 includes a magnet 18 (not shown in FIG. 1 ) that engages an exterior portion of a lock and holds device 10 in place. Magnet 18 may be fixedly attached to device 10 by securing magnet 18 in an opening 20 in device 10. Magnet 18 may fit snugly into opening 20 such that the firmness of the fit is sufficient to hold magnet 18 in place, or else magnet 18 may be attached to device 10 by use of adhesive or other suitable mechanisms known in the art. Although attachment portion 12 is shown as adapted to include a magnet 18, it is contemplated that other suitable attachment portions may also be used. For example, attachment portion 12 may include an adhesive portion such that lock protection device 10 can be removably attached to an exterior surface of a lock. Alternatively, attachment portion 12 may include a mock key portion or other protrusion that extends from attachment portion 12 to be received into a lock, thereby holding lock protection device 10 in place.

Once lock protection device 10 has been properly placed on a lock, as described above, protective covering 14 shields the lock from the elements. Annular sealing portion 16 preferably engages a surface around the lock and prevents, for example, rain from entering underneath lock protective device 10 and covering the lock. Although shown in the drawings as forming an annular seal, it is contemplated that protective covering 14 could be provided in any suitable size or shape, and may in some embodiments form a solid piece with attachment portion 12. Use of a protective covering 14 as shown in the drawings, however, is preferred, as this uses less manufacturing material than a solid piece, and also provides an air space between attachment portion 12 and protective covering 14 which can serve an insulating function in some instances where the present device in is use. Lock protection device 10 can still, however, be provided in a variety of shapes and sized, each with an interior space (or plurality of interior spaces) that may serve as insulators.

In another alternative embodiment of the present invention, annular sealing portion 16 contains at least one magnet located therein in order to assist in the sealing of annular sealing portion 16 to a surface around the lock that is being protected, such as, for example, a car door. In such an embodiment, a single, annular magnet may be used, positioned just beneath the surface of annular sealing portion 16 of lock protection device 10, or multiple magnets may be used spaced along the circumference of annular sealing portion 16. Alternatively, at least one magnet having a shape matching that of a portion of annular sealing portion 16 may be utilized, the magnet extending along at least a portion of the circumference of annular sealing portion 16. In other embodiments of the present invention having other sizes and shaped, magnet may be used as necessary or desirable in order to achieve the same sealing effect. Any other suitable mechanism for increasing the sealing effect of lock protection device 10 without damaging the surface around the lock being protected may also be used.

In a preferred embodiment of the present invention, lock protection device 10 is manufactured from silicon. It is preferred that the silicon used if of a thick grade, contributing to a rugged device 10, but is still pliable such that annular sealing portion 16, or a similar structure, is able to conform substantially to a surface on which lock protection device 10 is placed, thereby preventing rain and the elements from contacting the lock being protected.

Lock protection device 10 may also be manufactured from any suitable material, including rubber, vinyl, polyethylene, polypropylene, polyvinyl chloride, polystyrene, various other plastics, or any other suitable synthetic or natural materials, or combinations thereof. It is contemplated that upon reading this description, one of ordinary skill in the art will be able to manufacture the device from any suitable material.

Although lock protection device 10 is shown, as preferred, as constructed from a single, unitary piece of material, it is contemplated that the device may be constructed from multiple pieces of material fixedly attached to one another to form the entire device.

It is further contemplated that the size and shape of the various portions of lock protection device 10 may be modified in order to render lock protection device 10 better suited for a particular task. For example, attachment portion 12 may be sized or shaped differently depending on the type of lock being protected (i.e. a car door lock versus a lock on a front door to a house). Furthermore, in some embodiments of the present invention, attachment portion 12 may be recessed with respect to annular sealing portion 16 for use with locks where an outer surface of the lock extends away from the surface in which the lock is set. It is contemplated that the preferred embodiment of lock protection device 10 will be suitable for use with most locks, however modifications to the size, shape, position, or other dimensions of the present device may be made to accommodate and given lock, and may be made without departing from the spirit or scope of the present invention.

In addition, in some embodiments of the present invention, annular sealing portion 16, as shown in FIG. 1, may be left out. In those embodiments of the invention, attachment portion 12 may seal snugly to a lock being protected by device 10, such that an edge of attachment portion 12 prevents moisture, such as rain or other elements, from penetrating device 10 and entering the lock. The present device also functions to keep dust and other foreign material form entering the lock, thereby allowing the lock to operate more effectively and in some cases increases the life of the lock.

In any of the embodiments of the present invention described above, various colors and designs may be used to make the device more appealing to a potential purchaser. Colors may be used, for example, to mimic or approximate the color of the surface upon which the device is to be used, thereby rendering the device unobtrusive. Likewise, the present device may be provided with company logos or graphics, logos associated with sports teams, logos associated with musical bands, and the like. The inclusion of a graphical portion of this sort will appeal to fans of the sport, band, or other entity associated with the logo, and in this context as well as in the context of corporate logos, the device may be used as an advertising vehicle. Any sort of graphical image or design may be used on the present invention without departing from the spirit or scope of the invention.

The detailed description set forth above is provided to aid those skilled in the art in practicing the present invention. The invention described and claimed herein, however, is not to be limited in scope by the specific embodiments disclosed because these embodiments are intended to be illustrative of several aspects of the invention. Any equivalent embodiments are intended to be within the scope of the present invention. Various modifications of the invention which do not depart from the spirit or scope of the present invention, in addition to those shown and described herein, will become apparent to those skilled in the art from the foregoing description. Such modifications are also intended to fall within the scope of the appended claims.

1. A device for protecting a lock comprising:
a protective covering for protecting a lock; and
an attachment portion fixedly attached to said protective covering,
wherein said attachment portion is adapted to be removably attached to said lock.

2. The device according to claim 1 further comprising a sealing portion fixedly attached to said protective covering, said sealing portion adapted to contact a surface containing a lock in a substantially flush fashion when said attachment portion of said device is attached to said lock.

3. The device according to claim 2 wherein said sealing portion extends along a perimeter of said protective covering.

4. The device according to claim 2 wherein said sealing portion is an annular sealing portion.

5. The device according to claim 1 wherein said attachment portion comprises at least one opening adapted to receive a magnet therein, and wherein said device further comprises a magnet portion fixedly contained within said at least one opening in said attachment portion.

6. The device according to claim 1 wherein said attachment portion comprises an adhesive such that said attachment portion can be removably attached to a lock.

7. The device according to claim 1 wherein said attachment portion includes a protruding portion adapted to be received within a keyhole of said lock.

8. The device according to claim 7 wherein said protruding portion is a mock key.

9. The device according to claim 1 wherein said device is constructed from a material selected from the group consisting of silicon, rubber, vinyl, polyethylene, polypropylene, polyvinyl chloride, polystyrene, and combinations thereof.

10. The device according to claim 1 wherein said protective covering further comprises a graphical portion on a surface thereof.

11. A device for protecting a lock comprising:
a protective covering for protecting a lock, said protective covering being substantially circular in shape;
an annular sealing portion extending along at least a portion of a perimeter of said protective covering and fixedly attached thereto, said sealing portion adapted to contact a surface containing a lock in a substantially flush fashion when said device is in operable position with respect to a lock; and
an attachment portion fixedly attached to said protective covering,
wherein said attachment portion is adapted to be removably attached to said lock.

12. The device according to claim 11 wherein said attachment portion comprises at least one opening adapted to receive a magnet therein, and wherein said device further comprises a magnet portion fixedly contained within said at least one opening in said attachment portion.

13. The device according to claim 11 wherein said attachment portion comprises an adhesive such that said attachment portion can be removably attached to a lock.

14. The device according to claim 11 wherein said attachment portion includes a protruding portion adapted to be received within a keyhole of said lock.

15. The device according to claim 11 wherein said protective covering further comprises a graphical portion on a surface thereof.

16. The device according to claim 11 wherein said device is constructed from a material selected from the group consisting of silicon, rubber, vinyl, polyethylene, polypropylene, polyvinyl chloride, polystyrene, and combinations thereof.

17. The device according to claim 2 wherein said sealing portion comprises at least one magnet for sealing said sealing portion to a surface.

18. The device according to claim 11 wherein said sealing portion comprises at least one magnet for sealing said sealing portion to a surface.
